(19) United States
(12) Patent Application Publication
(10) Pub. No.: US 2025/0016898 A1
(43) Pub. Date: Jan. 9, 2025

(54) LIGHT-EMITTING ELEMENT DRIVING DEVICE, LIGHT-EMITTING DEVICE, AND VEHICLE

(71) Applicant: ROHM CO., LTD., Kyoto (JP)

(72) Inventors: Ryo TAKAGI, Kyoto (JP); Akira AOKI, Kyoto (JP)

(21) Appl. No.: 18/891,075

(22) Filed: Sep. 20, 2024

Related U.S. Application Data
(63) Continuation of application No. PCT/JP2023/005738, filed on Feb. 17, 2023.

(30) Foreign Application Priority Data
Mar. 31, 2022 (JP) 2022-060073

(51) Int. Cl. H05B 45/325; H05B 45/10

(52) U.S. Cl. CPC H05B 45/325; H05B 45/10

(57) ABSTRACT

A light-emitting element driving device includes an error amplifier configured to output a voltage corresponding to the difference between a voltage corresponding to the current flowing through a light-emitting element and a reference voltage, and to switch between an operating state and a non-operating state according to a control signal; a driver configured to drive, based on the output voltage of the error amplifier, a switching element in a voltage feeder configured to feed a voltage to the light-emitting element; and a suppressor configured, when the error amplifier switches from the non-operating state to the operating state, to suppress a rise in the output voltage of the error amplifier.

### CROSS-REFERENCE TO RELATED APPLICATIONS

This nonprovisional application is a continuation application of International Patent Application No. PCT/JP2023/005738 filed on Feb. 17, 2023, which claims priority to Japanese Patent Application No. 2022-060073 filed in Japan on March 231, 2022, the entire contents of which are hereby incorporated by reference.

### BACKGROUND OF THE INVENTION

### 1. Technical Field

The disclosure herein relates to a light-emitting element driving device, and to a light-emitting device and a vehicle that employ the light-emitting element driving device.

### 2. Description of Related Art

Some known light-emitting devices have a PWM (pulse width modulation) dimming switch (see, for example, Japanese Unexamined Patent Application Publication No. 2013-132107).

### BRIEF DESCRIPTION OF THE DRAWINGS

FIG. 1 is a diagram showing one configuration example of a light-emitting device.

FIG. 2 is a diagram showing an example of the waveforms of currents and voltages.

FIG. 3 is a diagram showing one configuration example of a PWM dimming signal generator provided in an LED driver IC.

FIG. 4 is a diagram showing another configuration example of a PWM dimming signal generator provided in the LED driver IC.

FIG. 5 is a diagram showing an example of the waveform of a current flowing through a light-emitting diode.

FIG. 6 is an exterior view (front side) of a vehicle incorporating light-emitting devices.

FIG. 7 is an exterior view (rear side) of a vehicle incorporating light-emitting devices.

FIG. 8 is an exterior view of an LED headlight module.

FIG. 9 is an exterior view of an LED turn-signal lamp module.

FIG. 10 is an exterior view of an LED rear lamp module.

### DESCRIPTION OF EMBODIMENTS

In this description, a MOS (metal-oxide-semiconductor) field-effect transistor denotes a field-effect transistor of which the gate has a structure composed of at least three layers, that is, a layer of a conductor or of a semiconductor with a low resistance value such as polysilicon, a layer of an insulator, a layer of a P-type, N-type, or intrinsic semiconductor. That is, the structure of the gate of a MOS field-effect transistor is not limited to the three-layer structure of metal, oxide, and semiconductor.

In this description, a reference voltage denotes a voltage that is constant under ideal conditions, and this can be a voltage that varies slightly with variation in temperature or the like.

### <Light-Emitting Device>

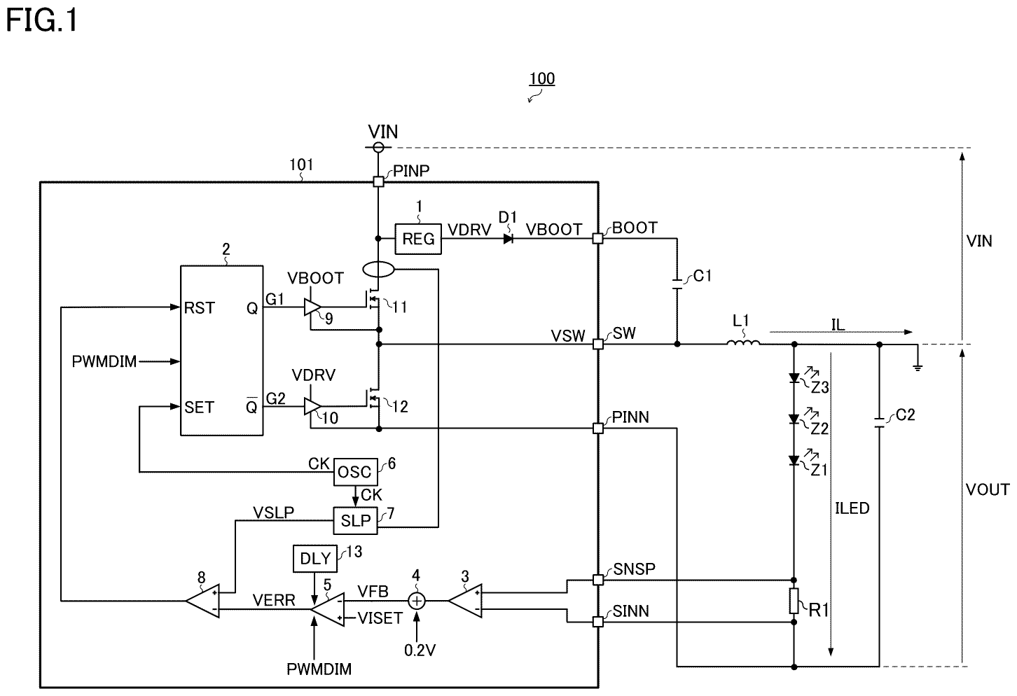

FIG. 1 is a diagram showing one configuration example of a light-emitting device. The light-emitting device 100 shown in FIG. 1 has light-emitting diodes Z1 to Z3 as light-emitting elements and an LED (light-emitting diode) driver IC (integrated circuit) 101 that drives the light-emitting elements.

In addition to the light-emitting diodes Z1 to Z3, a capacitor C1, an inductor L1, an output capacitor C2, and a sense resistor R1 are externally connected to the LED driver IC 101.

The LED driver IC 101 has, for establishing electrical connection with the outside, a terminal PINP, a terminal BOOT, a terminal SW, a terminal PINN, a terminal SNSP, and a terminal SINN.

The first terminal of the capacitor C1 is connected to the terminal BOOT. The second terminal of the capacitor C1 and the first terminal of the inductor L1 are connected together to the terminal SW.

The second terminal of the inductor L1 is connected to the anode of the light-emitting diode Z1, to the first terminal of the output capacitor C2, and to a ground potential.

The cathode of the light-emitting diode Z1 is connected to the anode of the light-emitting diode Z2. The cathode of the light-emitting diode Z2 is connected to the anode of the light-emitting diode Z3.

The cathode of the light-emitting diode Z2 is connected to the terminal SNSP and to the first terminal of the sense resistor R1.

The second terminal of the sense resistor R1 is connected to the terminal SINN and to the second terminal of the output capacitor C2,

The LED driver IC 101 has a constant voltage circuit 1, a control circuit 2, an operation amplifier 3, an adder 4, an error amplifier 5, an oscillator 6, a slope circuit 7, a comparator 8, drivers 9 and 10, N-channel MOS transistors 11 and 12, a delay circuit 13, and a diode D1.

The constant voltage circuit 1 generates a constant voltage VDRV from an input voltage VIN fed to the terminal PINP and feeds the constant voltage VDRV to different parts of the LED driver IC 101 including the anode of the diode D1. The cathode of the diode D1 is connected to the terminal BOOT. A bootstrap circuit constituted by the diode D1 and the capacitor C1 produces at the terminal BOOT a voltage VBOOT higher than a voltage VSW fed to the terminal SW.

A gate signal G1 is output from the output terminal Q of the control circuit 2. A gate signal G2 is output from an inverting output terminal Q-bar of the control circuit 2. The control circuit 2 sets the gate signal G1 according to a signal fed to a set terminal SET and resets the gate signal G1 according to a signal fed to a reset terminal RST. The control circuit 2 operates when a PWM dimming signal PWMDIM is at high level and does not operate when the PWM dimming signal PWMDIM is at low level. When the control circuit 2 is not operating, the gate signals G1 and G2 are both at low level.

The non-inverting input terminal of the operational amplifier 3 is connected to the terminal SNSP and the inverting input terminal of the operational amplifier 3 is connected to the terminal SINN. The operational amplifier 3 outputs a voltage corresponding to the voltage across the sense resistor R1.

The output voltage of the operational amplifier 3 is offset by the adder 4 so as to increase by 0.2 V. A feedback voltage VFB generated by the adder 4 is fed to the inverting input terminal of the error amplifier 5. The feedback voltage VFB is a voltage based on the current ILED flowing through the light-emitting diodes Z1 to Z3.

The error amplifier 5 generates an error voltage VERR according to the difference between the feedback voltage VFB and a reference voltage VISET. The reference voltage VISET is a voltage for setting the value of the current ILED flowing through the light-emitting diodes Z1 to Z3. The higher the reference voltage VISET, the higher the value of the current ILED flowing through the light-emitting diodes Z1 to Z3.

The oscillator 6 generates a clock signal CK. The clock signal CK is fed to the slope circuit 7 and to the set terminal SET of the control circuit 2.

The slope circuit 7 generates a slope voltage VSLP by adding up, using the clock signal CK, a lamp waveform voltage with a triangle or sawtooth waveform and a voltage according to information on ripples in the current IL flowing through the inductor L1.

The comparator 8 compares the error voltage VERR and the slope voltage VSLP and feeds the result of the comparison to the reset terminal RST of the control circuit 2.

The driver 9 feeds a driving signal obtained by amplifying the gate signal G1 to the gate of the MOS transistor 11. The positive supply terminal of the driver 9 is fed with the voltage VBOOT and the negative supply terminal of the driver 9 is fed with the voltage VSW.

The driver 10 feeds a driving signal obtained by amplifying the gate signal G2 to the gate of the MOS transistor 12. The positive supply terminal of the driver 10 is fed with the voltage VDRV and the negative supply terminal of the driver 10 is fed with a voltage fed to the terminal PINN.

The drain of the MOS transistor 11 is connected to the terminal PINP. The source of the MOS transistor 11 and the drain of the MOS transistor 12 are connected to the terminal SW. The source of the MOS transistor 12 is connected to the terminal PINN.

A voltage feeder constituted by the MOS transistors 11 and 12, the inductor L1, and the output capacitor C2 feeds a voltage to the light-emitting diodes Z1 to Z3.

The delay circuit 13 will be described later.

The LED driver IC 101 is a negative buck-boost DC/DC converter type LED driver IC. In the light-emitting device 100, when the MOS transistor 11 is on and the MOS transistor 12 is off, energy is stored in the inductor L1. In the light-emitting device 100, when the MOS transistor 11 is off and the MOS transistor 12 is on, the current IL flowing through the inductor L1 negatively charges the output capacitor C2.

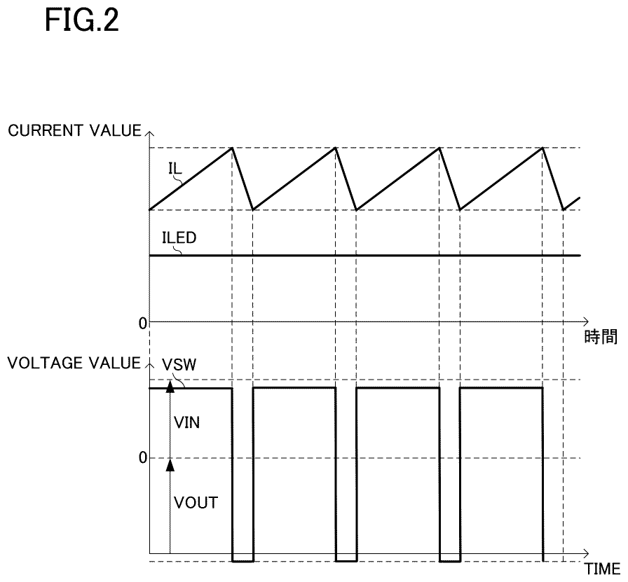

When the PWM dimming signal PWMDIM is at high level, the error amplifier 5 operates. The error amplifier 5, when operating, outputs from the output terminal the error voltage VERR corresponding to the difference between the feedback voltage VFB and the reference voltage VISET. When the error amplifier 5 is operating, the MOS transistors 11 and 12 perform switching operation, and as shown in FIG. 2, the current IL flowing through the inductor L1 has a triangular waveform and the voltage VSW has a pulsed waveform.

When the PWM dimming signal PWMDIM is at low level, the error amplifier 5 does not operate. When the error amplifier 5 is not operating, the output terminal of the error amplifier 5 is in a high-impedance state.

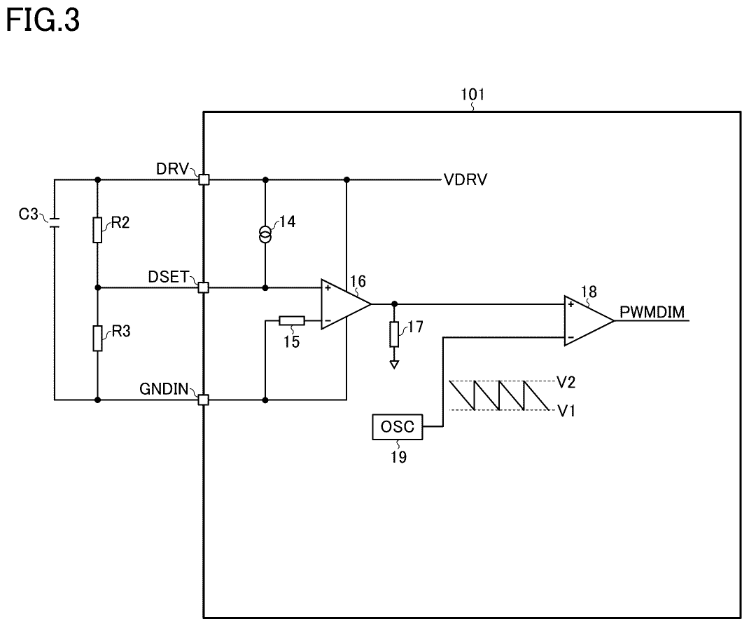

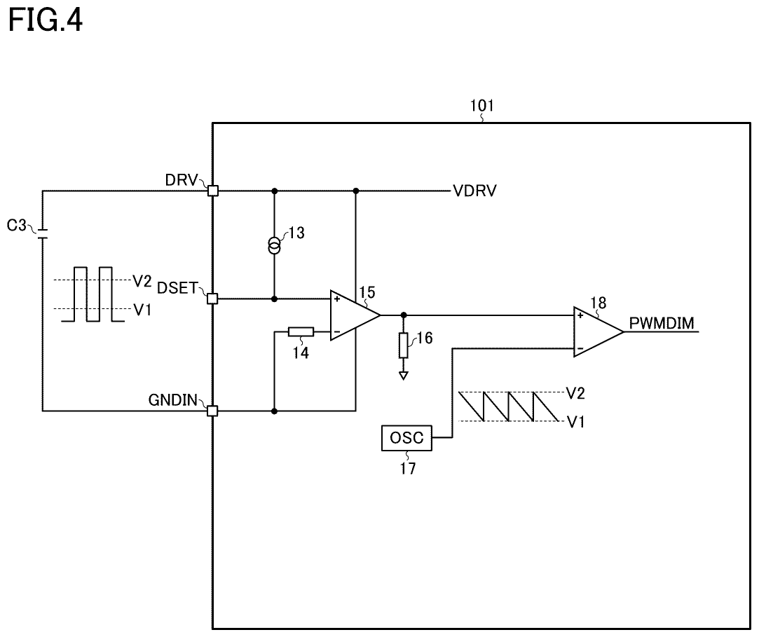

The LED driver IC 101 has a PWM dimming signal generator. FIGS. 3 and 4 is a diagram showing one configuration example of the PWM dimming signal generator provided in the LED driver IC 101.

The PWM dimming signal generator of the configuration example shown in FIGS. 3 and 4 has a current source 14, resistors 15 and 17, comparators 16 and 18, and an oscillator 19. The LED driver IC 101 further has, for establishing electrical connection with the outside, a terminal DRV, a terminal DSET, and a terminal GNDIN.

A constant voltage VDRV output from the constant voltage circuit 1 is fed to the terminal DRV, to the first terminal of the current source 14, and to the positive supply terminal of the comparator 16. The second terminal of the current source 14 is connected to the terminal DSET and to the non-inverting input terminal of the comparator 16.

The terminal GNDIN is connected to the first terminal of the resistor 15 and to the negative supply terminal of the comparator 16. The second terminal of the resistor 15 is connected to the inverting-input terminal of the comparator 16.

The output terminal of the comparator 16 is connected to the first terminal of the resistor 17 and to the non-inverting input terminal of the comparator 18. The second terminal of the resistor 17 is connected to the terminal SINN (see FIG. 1). The output signal of the oscillator 19 is fed to the inverting input terminal of the comparator 18. The output signal of the oscillator 19 is a signal having a sawtooth of which the bottom value is V1 and of which the top value is V2. The comparator 18 outputs the PWM dimming signal PWMDIM.

In the configuration shown in FIG. 3, the frequency of the PWM dimming signal PWMDIM is fixed internally. In the configuration shown in FIG. 3, a capacitor C3 and resistors R2 and R3 are externally connected to the LED driver IC 101. The first terminal of the capacitor C3 and the first terminal of the resistor R2 are connected to the terminal DRV. The second terminal of the resistor R2 and the first terminal of the resistor R3 are connected together to the terminal DSET. The second terminal of the capacitor C3 and the second terminal of the resistor R3 are connected to the terminal GNDIN. In the configuration shown in FIG. 3, the frequency of the PWM dimming signal PWMDIM is equal to the frequency of the output signal of the oscillator 19. In the configuration shown in FIG. 3, the on duty of the PWM dimming signal PWMDIM depends on the voltage fed to the terminal DSET.

In the configuration shown in FIG. 4, the frequency of the PWM dimming signal PWMDIM is determined by the signal externally input to the terminal DSET. In the configuration shown in FIG. 4, the capacitor C3 is externally connected to the LED driver IC 101. The first terminal of the capacitor C3 is connected to the terminal DRV. The second terminal of the capacitor C3 is connected to the terminal GNDIN. The terminal DSET is fed with a PWM signal. When the PWM signal fed to the terminal DSET is equal to or higher than V2, the PWM dimming signal PWMDIM is at high level, and when the PWM signal fed to the terminal DSET is equal to or lower than V1, the PWM dimming signal PWMDIM is at low level. Thus, in the configuration shown in FIG. 3, the frequency of the PWM dimming signal PWMDIM is equal to the frequency of the PWM signal fed to the terminal DSET.

Next, the delay circuit 13 provided in the LED driver IC 101 will be described.

First, to describe the role of the delay circuit 13, a description will be given of the LED driver IC 101 without the delay circuit 13. When the PWM dimming signal PWMDIM is at low level, the switching operation of the MOS transistors 11 and 12 is suspended and electric charge is extracted from the output capacitor C2 via the light-emitting diodes Z1 to Z3. Thus, when the PWM dimming signal PWMDIM is at low level, the output voltage VOUT falls. After that, when the PWM dimming signal PWMDIM switches from low level to high level, the error amplifier 5 switches from a non-operating state to an operating state. At the timing when the error amplifier 5 switches from the non-operating state to the operating state, no current flows through the light-emitting diodes Z1 to Z3, and thus the error voltage VERR output from the error amplifier 5 is at its maximum. Thus, the output voltage VOUT rises so high as to cause an overshoot in the current flowing through the light-emitting diodes Z1 to Z3.

The delay circuit 13, when the error amplifier 5 switches from the non-operating state to the operating state, suppresses a rise in the error voltage VERR output from the error amplifier 5. As a result, as shown in FIG. 5, when the error amplifier 5 switches from the non-operating state to the operating state, an overshoot in the current ILED flowing through the light-emitting diodes Z1 to Z3 is suppressed.

Specifically, the delay circuit 13 is configured to switch the error amplifier 5 from the non-operating state to the operating state with a delay from a switch of the PWM dimming signal PWMDIM from low level to high level. The delay time in the delay circuit 13 may be set to the time at the lapse of which the charging of the output capacitor C2 is complete and the feedback voltage VFB rises to around the reference voltage VISET.

The time T_charge at the lapse of which the charging of the output capacitor C2 is complete and the feedback voltage VFB rises to around the reference voltage VISET can be calculated according to the formula below. In the formula, C2 represents the capacitance of the output capacitor C2; ΔV represents the difference between the reference voltage VISET and the feedback voltage VFB; I_charge represents the charge current through the output capacitor C2; ILED represents the current flowing through the light-emitting diodes Z1 to Z3; and Don represents the on duty of the MOS transistor 12.

$$T\_charge = C 2 \times Δ V / I\_charge$$

At the start of charging, I_charge=ILED/(1−Don)

In the steady state, I_charge={ILED/(1−Don)}−ILED

The delay circuit 13 generates the delay time from the timing of the switch of the PWM dimming signal PWMDIM from low level to high level. Configuring the delay circuit 13 with a logic circuit makes it easy to generate the delay time.

For example, holding the delay time in a register within the logic circuit permits the delay time to be fixed.

For example, a detection circuit that detects the output voltage VOUT having reached a set value may be provided in the LED driver IC 101 so that the delay circuit 13 can use the output of the detection circuit as a trigger to recognize the end of the delay.

For example, leaving the delay time held in the register within the logic circuit rewritable permits the delay time to be varied.

### <Applications>

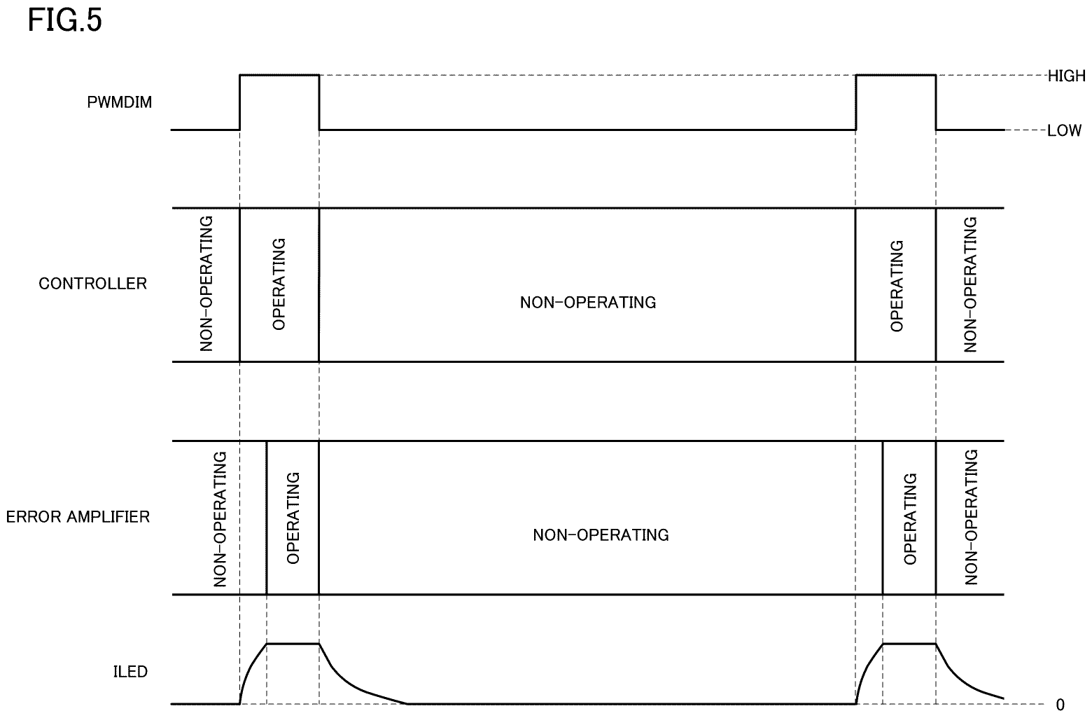

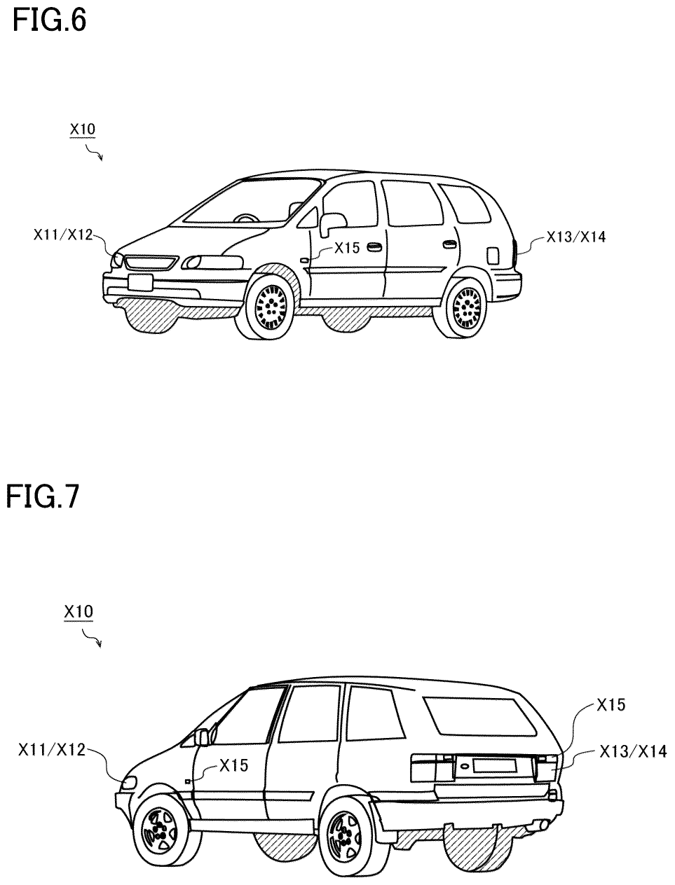

The light-emitting device described previously, for example, as shown in FIGS. 6 and 7, can be suitably used as a headlight (including a high beam light, a low beam light, a sidelight, a fog light, or the like as appropriate) X11 of a vehicle X10, a light source X12 for a daytime running light (DRL), a tail lamp (including a sidelight, a backup light, or the like as appropriate) X13, a stoplight X14, or a turn-signal lamp X15.

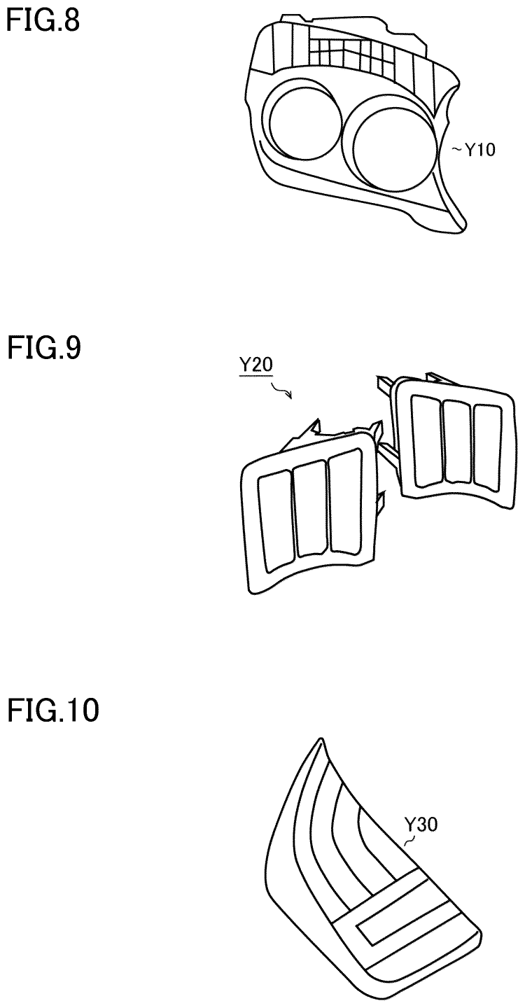

The light-emitting device described previously can be provided as a module (an LED headlight module Y10 in FIG. 8, an LED turn-signal lamp module Y20 in FIG. 9, an LED rear lamp module Y30 in FIG. 10, or the like). It may instead be provided in the form of a semi-finished product that results from removing the light-emitting diodes and the external components of a light-emitting element driving IC from the light-emitting device described previously.

### <Others>

The above-described embodiments should be understood that are in every aspect illustrative and not restrictive. The technical scope of the disclosure herein is defined not by the description of the embodiments given above but by the appended claims, and encompasses any modifications made within a scope equivalent in significance to those claims.

In the embodiments described above, a configuration employing light-emitting diodes as light-emitting elements is described as an example, but the configuration of the disclosure herein is not limited to that; instead, for example, organic EL (electroluminescence) elements may be employed as light-emitting elements.

In the embodiments described above, a negative buck-boost DC/DC converter type LED driver IC is described as an example, but the configuration of the disclosure herein is not limited to that; instead, for example, a non-negative LED driver may be employed.

In the embodiments described above, a PWM dimming signal is employed, but instead of a PWM dimming signal, a pulse modulation dimming signal other than a PWM dimming signal may be used. Examples of pulse modulation dimming signals other than a PWM dimming signal include a PFM (pulse-frequency modulation) dimming signal and a PDM (pulse-density modulation) dimming signal.

In the embodiments described above, the delay of a switch of the error amplifier 5 from a non-operating state to an operating state is used to suppress, when the error amplifier 5 switches from the non-operating state to the operating state, a rise in the error voltage VERR output from the error amplifier 5. However, any method that does not rely on a delay can be used to suppress, when the error amplifier 5 switches from the non-operating state to the operating state, a rise in the error voltage VERR output from the error amplifier 5.

For example, instead of the delay circuit 13, a clamp circuit that clamps the error voltage VERR output from the error amplifier 5 may be provided. However, the error voltage VERR output from the error amplifier 5 changes depending on the reference voltage VISET, so the clamp voltage cannot be uniquely set. This complicates the circuit configuration of the clamp circuit.

For example, instead of the delay circuit 13, a discharge circuit may be provided. The discharge circuit, when the PWM dimming signal PWMDIM is at low level, discharges the error voltage VERR and drops the error voltage VERR. However, dropping the error voltage VERR results in a longer time taken, when the PWM dimming signal PWMDIM switches from low level to high level, for the error voltage VERR to rise. Thus, when the on duty of the PWM dimming signal PWMDIM is low, the current ILED flowing through the light-emitting diodes Z1 to Z3 cannot be output. This makes the guaranteed operating range narrower.

According to one aspect of what is disclosed herein, a light-emitting element driving device (101) includes an error amplifier (5) configured to output a voltage corresponding to the difference between a voltage corresponding to the current flowing through a light-emitting element (Z1-Z3) and a reference voltage, and to switch between an operating state and a non-operating state according to a control signal; a driver (2, 9, 10) configured to drive, based on the output voltage of the error amplifier, a switching element (11, 12) in a voltage feeder (11, 12, L1, C2) configured to feed a voltage to the light-emitting element; and a suppressor (13) configured, when the error amplifier switches from the non-operating state to the operating state, to suppress a rise in the output voltage of the error amplifier. (A first configuration.)

The light-emitting element driving device of the first configuration described above can suppress an overshoot in the current flowing through the light-emitting element.

In the light-emitting element driving device of the first configuration described above, the control signal may be a PWM dimming signal. (A second configuration.)

The light-emitting element driving device of the second configuration described above can enhance the versatility of a control signal.

In the light-emitting element driving device of the first or second configurations described above, the suppressor may be configured to switch the error amplifier from the non-operating state to the operating state with a delay from a switch of the control signal from a first level to a second level. (A third configuration.)

The light-emitting element driving device of the third configuration described above helps avoid a complicated circuit configuration and a narrow guaranteed operating range.

In the light-emitting element driving device of the third configuration described above, the delay may be a fixed time. (A fourth configuration.)

The light-emitting element driving device of the fourth configuration described above helps implement a suppressor with a simple configuration.

In the light-emitting element driving device of the third configuration described above, the suppressor may keep the delay until the voltage fed from the voltage feeder to the light-emitting element reaches a set value. (A fifth configuration.)

The light-emitting element driving device of the fifth configuration described above helps optimize a delay time.

In the light-emitting element driving device of the third configuration described above, the delay may be a variable time. (A sixth configuration.)

The light-emitting element driving device of the sixth configuration described above permits adjustment of the delay time.

In the light-emitting element driving device of any one of the third to sixth configurations described above, the suppressor may be a logic circuit. (A seventh configuration.)

The light-emitting element driving device of the seventh configuration described above permits easy generation of the delay time.

According to another aspect of what is disclosed herein, a light-emitting device (100) includes the light-emitting element driving device of any one of the first to seventh configurations described above and the light-emitting element. (An eighth configuration.)

The light-emitting device of the eighth configuration described above can suppress an overshoot in the current flowing through a light-emitting element.

In the light-emitting device of the eighth configuration described above may further include a sense resistor (R1) configured to detect the current flowing through the light-emitting element. The light-emitting element and the sense resistor may be connected directly in series. (A ninth configuration.)

The light-emitting device of the ninth configuration described above has a configuration with no switch provided between the light-emitting element and the sense resistor, and this helps reduce cost.

According to yet another aspect of what is disclosed herein, a vehicle (X10) includes the light-emitting device of the eighth or ninth configurations described above. (A tenth configuration.)

The vehicle of the tenth configuration described above can suppress an overshoot in the current flowing through a light-emitting element.

What is claimed is:

1. A light-emitting element driving device comprising:
an error amplifier configured
to output a voltage corresponding to a difference between a voltage corresponding to a current flowing through a light-emitting element and a reference voltage and
to switch between an operating state and a non-operating state according to a control signal;
a driver configured to drive, based on an output voltage of the error amplifier, a switching element in a voltage feeder configured to feed a voltage to the light-emitting element; and
a suppressor configured, when the error amplifier switches from the non-operating state to the operating state, to suppress a rise in the output voltage of the error amplifier.

2. The light-emitting element driving device according to claim 1, wherein
the control signal is a PWM dimming signal.

3. The light-emitting element driving device according to claim 1, wherein
the suppressor is configured to switch the error amplifier from the non-operating state to the operating state with a delay from a switch of the control signal from a first level to a second level.

4. The light-emitting element driving device according to claim 3, wherein
the delay is a fixed time.

5. The light-emitting element driving device according to claim 3, wherein
the suppressor keeps the delay until a voltage fed from the voltage feeder to the light-emitting element reaches a set value.

6. The light-emitting element driving device according to claim 3, wherein
the delay is a variable time.

7. The light-emitting element driving device according to claim 3, wherein
the suppressor is a logic circuit.

8. The light-emitting element driving device according to claim 4, wherein
the suppressor is a logic circuit.

9. The light-emitting element driving device according to claim 5, wherein
the suppressor is a logic circuit.

10. The light-emitting element driving device according to claim 6, wherein
the suppressor is a logic circuit.

11. A light-emitting device comprising:
the light-emitting element driving device according to claim 1; and
the light-emitting element.

12. The light-emitting device according to claim 11, further comprising:
a sense resistor configured to detect a current flowing through the light-emitting element,
wherein
the light-emitting element and the sense resistor are connected directly in series.

13. A vehicle comprising:
the light-emitting device according to claim 11.

14. A vehicle comprising:
the light-emitting device according to claim 12.
